(19) United States
(12) Patent Application Publication
(10) Pub. No.: US 2023/0302349 A1
(43) Pub. Date: Sep. 28, 2023

(54) Strategy Multiplication Game

(71) Applicant: Nancy Scott Field, Soda Springs, CA (US)

(72) Inventor: Nancy Scott Field, Soda Springs, CA (US)

(21) Appl. No.: 17/702,481

(22) Filed: Mar. 23, 2022

(51) Int. Cl. A63F 3/04; G09B 19/02

(52) U.S. Cl. CPC A63F 3/0415; G09B 19/02; A63F 2003/046; A63F 2003/0418

(57) ABSTRACT

A math game that requires choice and strategic thinking in the practice of multiplication. Play takes place on a game board which consists of a grid of randomly arranged multiplication products. Players are given a “hand” of three or more numbered cards, with each number representing a factor in a multiplication problem. Players take turns choosing two of the factors in their hand to create a product which they mark on the game board. The first player to obtain the required number of marked products in a row, horizontally, vertically, or diagonally, wins the game. By choosing which factors they multiply, players can make offensive or defensive moves in their attempt to be the first to mark the required number of products in a row.

### BACKGROUND

### Field of the Invention

The invention is in the field of math games focusing on multiplication.

### Discussion of State of the Art

Many students struggle to learn and master multiplication math facts, and games can be essential pedagogical tools for parents and educators. Educational math games can provide practice that is more interesting, more engaging and more challenging than flash cards, worksheets or drills. Games that require players to make strategic choices during play, rather than having play determined by chance, can be especially engaging to players of all ages and levels.

U.S. Pat. No. 6,116,603 titled “Apparatus and Method of Playing a Math Capturing Game” (inventor Huang) includes triangular shaped game boards that show multiplication products placed in order, not randomly, alongside their factors. Players roll eight-sided dice to determine two factors which they will multiply and mark on their board. The first player to mark nine products wins. Huang's game does not include the element of strategy for offensive and defensive play that exists in the present invention. Players roll two dice to determine the factors they will use to create a product, and the winner in Huang's game is largely determined by chance, not strategy.

U.S. Pat. No. 6,695,618 titled “Multiplication Game” (inventor Donn) allows for repeated practice of identifying the factors for a given multiplication product. The Donn game board includes multipliers (factors) on the periphery and a blank grid in the middle. On each turn, a player draws one tile marked with a product that they then place on an appropriate location on the game board. The winner of the Donn game can be determined by the sum of the products on the chips, or the total number of chips played by a player or a team of players. The Donn game is different from the present game in a number of ways:
1) the board is different in the Donn game, as the center of the board grid is empty, and it has factors on the periphery;
2) in the Donn game a player draws one product tile, but in the present game the player has a variety of factors from which to choose a variety of products;
3) by choosing from a variety of factors, the present game is designed to build an intuitive sense of combinations, while the Donn game does not include this element; and
4) because the winner of the present game is determined by one player having a required number in a row, strategy for offensive and defensive play is different than in the Donn game.

U.S. Pat. No. 4,379,700 titled “Multiplication/Division Tutorial Game” (inventor Pollock) provides players repeated practice of multiplication. In the Pollock game, each player has a placemat holding a variety of numbered cards, and players capture chips by combining pairs of cards to match the product (or quotient) designated on chips. The Pollock game is different from the present game in a variety of ways:
1) instead of a board, there are three stacks of chips;
2) players practice both multiplication and division;
3) players attempt to create one of three possible products or quotients, rather than calculating the different products they can make from their hand of factors;
4) players do not try to get a required number of markers in a row;
the strategic thinking for offensive and defensive play is different; and
4) the game does not build an intuitive understanding of combinations.

The design in U.S. Pat. No. 3,009,262 titled “Educational Toy for Teaching Multiplication Table” (inventor Moran) has products on a rectangular grid, but the Moran toy is a device for learning math facts, not a game. The present invention is a game that involves the repeated practice of multiplication math facts as well as offensive and defensive strategy.

U.S. Pat. No. 3,571,953 titled “Multiplication Game” (inventor Hassell) uses a yardstick apparatus as a learning aid for multiplication. The yardstick apparatus for playing is different from the present board consisting of randomly placed products. The method of play is not the same as the present game, and there is no element allowing choice of factors. The strategic planning afforded by the present game is missing.

A variety of U.S. Pat. Nos. (#5,603,501, #6,341,779, #6,811,402 and #5,273,430, to list a few) give examples of prior art in the field of math games that incorporate choice in the selection of an operation (add, subtract, multiply, divide) when choosing play in a math game, not choice of factors. They differ significantly from the present game and do not focus on repeated multiplication practice.

There is a need for a game that incorporates the choice of factors (the numbers in a multiplication problem) in the focused practice of multiplication skills. Various word games, such as Scrabble, Upwords, and Boggle, allow players to choose from various letters to form words. The math game described herein allows players to choose strategically from a variety of factors to form different products.

Math students benefit from having a variety of ways to practice their multiplication math facts. The game described herein is believed to be unique.

### BRIEF SUMMARY OF THE INVENTION

The game apparatus is composed of: a board consisting of a grid of composite (non-prime) numbers; a set of cards each with one number, each number being a potential factor in a multiplication problem; and markers of two different colors. The game mechanics consist of a set of rules for two players who take turns starting with a hand of four cards (factors), choosing two factors from those options, covering the chosen product on the game board with a marker, and replacing the two cards (factors) used at the end of the turn. A player wins after marking the required number of products in a row horizontally, vertically, or diagonally. The game can be played in either digital or physical formats.

Because players choose from a set of available factors, players have a variety of products they can mark on each turn. This allows for offensive and defensive play. Players can choose to block an opponent, players can choose to play offensively, and players can consider which cards will be left in their hand for their next play. The invention provides extensive opportunities for strategic play, not just play determined by chance. In addition, the game builds an intuitive understanding of combinations, as well as providing repeated practice with multiplication.

### BRIEF DESCRIPTION OF THE SEVERAL VIEWS OF THE DRAWING

FIG. 1 shows a sample game board with multiplication products

FIG. 2 shows a sample of numbered cards

FIG. 3 shows a sample of markers

FIG. 4 shows a sample of a first turn in a game; the first player has four cards, numbered 3, 7, 4 and 8, and chooses to mark a specific location of the product of 12 on the board

FIG. 5 shows a sample game after two players have each taken four turns

FIG. 6 shows an alternative game board that excludes multiples of 7, 8, 9 or greater

### DETAILED DESCRIPTION OF THE INVENTION

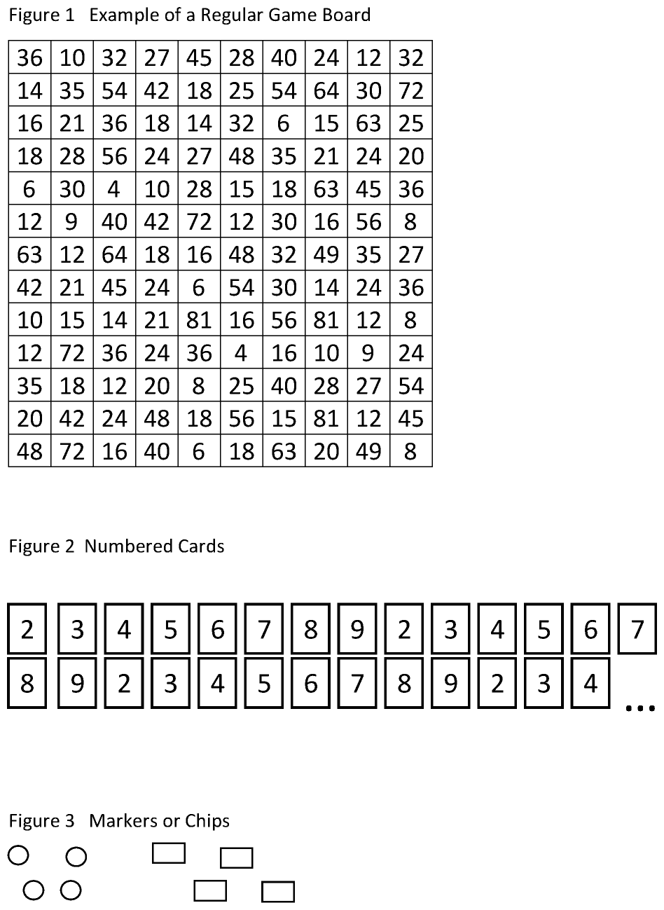

This two player game requires a game board consisting of a grid with multiplication products (FIG. 1), a variety of numbered cards (FIG. 2), and a set of markers (FIG. 3). The game can be either physical or digital.

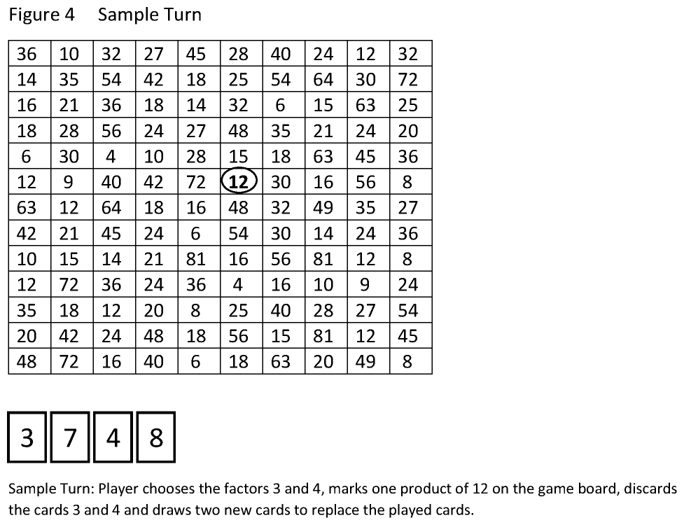

In the standard version of the game, players start each turn with a “hand” of four cards dealt from a shuffled set. The remaining cards are placed in a stack face down as a “draw” pile. On each turn, a player will choose two of the four cards in their hand to be the factors in a multiplication problem and cover the product of said multiplication problem with a marker on one space on the game board. For example, if Player 1 has a hand with the cards 3, 7, 4 and 8 (as shown in FIG. 4), the player could cover a 12 (the product of 3×4), a 21 (the product of 3×7), a 24 (the product of 3×8), a 28 (the product of 7×4), a 56 (the product of 7×8) or a 32 (the product of 4×8). The two cards that Player 1 chooses to use are placed in a “discard” pile, and Player 1 draws two more cards to the hand to replace the discarded cards at the end of the turn.

After Player 1 has finished their turn and covered the chosen product with a marker on the board, Player 2 takes a turn and repeats the same process: starting with four cards, they choose two factors to multiply, they cover a location of that product on the board with a colored marker, they discard the two used cards and they draw two new cards.

Play continues in this fashion.

Players may choose strategically when deciding which factors to use and which product to mark; players can play defensively by blocking their opponent, or players can play offensively in their effort to get five markers in a row. Once a product is covered, neither player may move or replace the marker until the game has ended. If a player has four cards and is unable to mark a single product, then the player chooses two cards to discard and draws two new cards without marking any product. If the draw pile runs out, the cards from the discard pile are shuffled and placed in the draw pile. The first player to have five markers in a row, horizontally, vertically, or diagonally wins the game. If the game advances to a point where neither player can get five markers in a row, the game ends in a tie. In addition to providing repeated practice of multiplication math facts and opportunities to plan strategically, the game described herein helps to build an intuitive understanding of combinations.

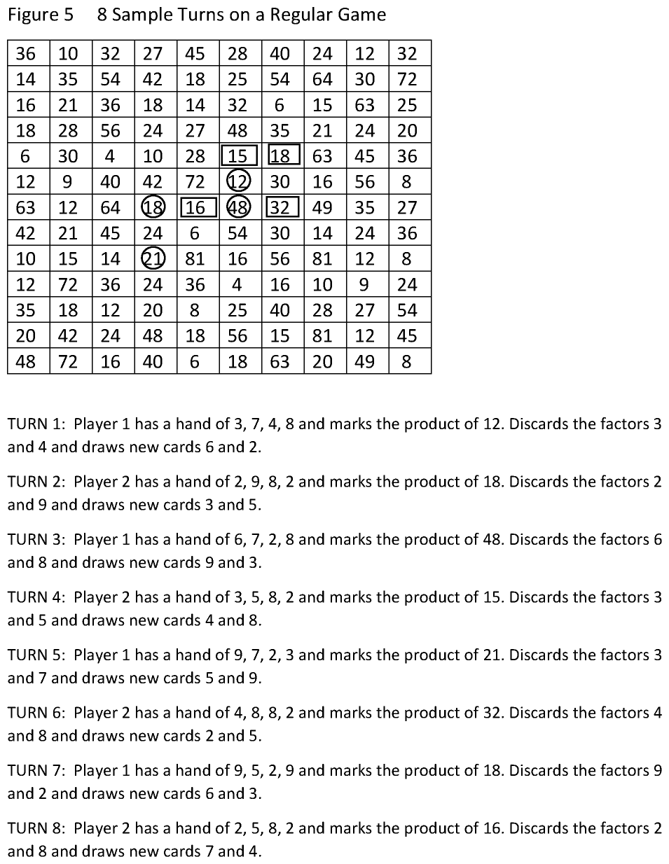

A game board is illustrated showing the first eight turns in a sample of the standard version of the game (FIG. 5).

Alternative methods of play may be utilized for players of various skill levels. Experienced players may start with a hand of five or more cards, increasing the number of possible products to consider. Less experienced players can play with a hand of three cards instead of four, thus limiting the number of products possible on each turn, or they might choose to require fewer markers in a row for a win. In all of these variations, play would be the same: taking turns, players choose two cards from those in their hand, cover the product of the two chosen cards, and then discard and replace the two cards used. Play continues until a player has the required number of markers in a row.

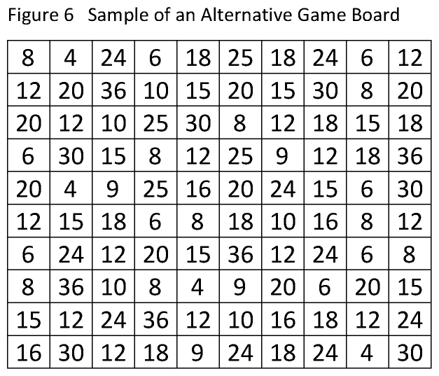

Anticipating players who prefer to practice with a smaller (or greater) set of multiplication math facts, alternative game boards are possible. For example, an alternative game board might exclude multiples of 7, 8, 9 or greater (FIG. 6) in order for players focus solely on multiplication math facts up to 6×6=36. In this case, the cards used would only contain the numbers 2 through 6 inclusive as the potential factors. Similarly, players might opt for a board that includes only multiplies of the number 4 through 12. With any of these alternative boards, the game rules remain the same (start with four cards, cover one product on each turn, etc.). In this alternative as before, the game rules could be modified so players start with only three cards and/or only require four markers in a row to win.

Alternative game boards of different sizes can accommodate different levels of play. A standard board consists of a 10 by 10 grid of numbers, but players might opt for a smaller grid (8 by 8, for example) or a larger grid (12 by 12, for example). Additionally, players might opt to allow more than two cards to be used to create a product (for example, 2, 3, and 9 have a product of 54), and in this variation three cards would need to be replaced at the end of a turn.

Players have the option of setting time limits for each turn or allowing unlimited time.

The basics of the game remain the same with any alternative version: choose factors that create a product, mark the product on a grid with the goal of marking the required number of products in a row.

1. A multiplication board game apparatus, comprising:
a. A playing board consisting of a grid of numbers, with said numbers being the products of multiplication;
b. A variety of cards inscribed with counting numbers that represent the factors in a multiplication problem; and
c. A variety of marking pieces (“markers”) of two different types.

2. Rules for using said apparatus, comprising:
a. Assigning to two players three or more of said numbered cards;
b. Placing remaining cards in a draw pile;
c. Assigning each player said markers of one type;
d. Taking turns in which players:
i. Choose two of the cards in said hand to be factors in a multiplication problem;
ii. Multiply to find the product of said two cards;
iii. Choose one location of said product on said playing board and cover with a marker;
iv. Discard said two cards in a discard pile;
v. Draw two new cards;
e. Passing a turn and exchanging two cards if a player cannot mark a product;
f. Declaring a winner when one player has a predetermined number of markers in a row vertically, horizontally, or diagonally;
g. Declaring a tie if neither player is able to obtain the predetermined number of markers in a row;
h. Allowing players, before starting a game, to agree on an alternative method of play that changes the number of cards assigned to each hand; and
i. Allowing players, before starting a game, to agree on a different number of markers in a row that are required to win;
j. Allowing players, before starting a game, to agree on an alternative board that is either smaller in size or contains a different range of factors; and
k. Allowing players, before starting a game, to allow for time limits on turns.
